(19) United States
(12) Patent Application Publication
(10) Pub. No.: US 2013/0179258 A1
(43) Pub. Date: Jul. 11, 2013

(54) SYSTEMS AND METHODS FOR CONDUCTING ELECTRONIC COMMERCE BY PROVIDING GROUP BUY OFFERS

(71) Applicant: NORTHCORE TECHNOLOGIES INC., Toronto (CA)

(72) Inventors: James Moskos, Mississauga (CA); Amit Singh Monga, Toronto (CA)

(73) Assignee: NORTHCORE TECHNOLOGIES INC., Toronto (CA)

(21) Appl. No.: 13/739,052

(22) Filed: Jan. 11, 2013

Related U.S. Application Data
(60) Provisional application No. 61/585,530, filed on Jan. 11, 2012.

(51) Int. Cl. G06Q 30/06

(52) U.S. Cl. CPC G06Q 30/0605
USPC 705/14.49

(57) ABSTRACT

Methods of conducting electronic commerce at a server by providing group buy offers are disclosed. In one aspect, the method involves receiving requests from group buy participants to participate in a group buy offer; determining that the group buy offer is valid once a minimum threshold number of initial group buy participants is met; offering an incentive to a selected initial group buy participant to share the initial group buy offer; receiving input from a subsequent group buy participant, the subsequent group buy participant having been shared the deal from the selected initial group buy participant; determining a relationship between the selected group buy participant and the subsequent group buy participant; assessing a degree of influence the selected group buy participant has on the subsequent group buy participant based on the relationship; and varying the incentive offered to the selected group buy participant corresponding to the assessed degree of influence.

### CROSS-REFERENCE TO RELATED APPLICATION

This application claims benefit of U.S. Provisional Patent Application No. 61/585,530, entitled “Systems and Methods for Conducting eCommerce by Providing Group Buy Offers”, filed Jan. 11, 2012. The entire contents of U.S. Provisional Patent Application No. 61/585,530 are hereby incorporated by reference.

### FIELD

The described embodiments relate to systems and methods for conducting electronic commerce by providing group buy offers.

### INTRODUCTION

Electronic commerce in the form of group buying, or collective buying, enables a single buyer to unite with one or more other buyers in order to obtain additional discounts or offers from merchants and/or service providers.

This type of group buying is typically conducted over a network such as the Internet. The general operation of group buys involves providing an offer for purchase of a good or service, where that offer is valid only if some condition is met. For example, a condition might require that a predefined threshold of buyers purchase the offer within a limited time period. If the predefined threshold of buyers is not met within the limited time period, the group buy offer is not valid and no buyer can purchase the group buy offer. If the predefined threshold of buyers is met within the limited time period, the group buy offer is valid and all buyers can purchase the group buy offer. The group buy offer may itself be available for only a specified time period, which may be the same as the limited time period.

### SUMMARY

The embodiments described herein provide in one aspect, a method of conducting electronic commerce at a server, the method comprising the server:

publishing an initial group buy offer;

receiving requests from a plurality of group buy participants to participate in the initial group buy offer;

determining that the initial group buy offer is valid once a minimum threshold number of initial group buy participants is met;

offering an incentive to a selected initial group buy participant to share the initial group buy offer;

receiving input from a subsequent group buy participant not included in the plurality of initial group buy participants requesting to participate in the initial group buy offer, wherein the input indicates that the selected initial group buy participant shared the initial group buy offer with the subsequent group buy participant;

determining a relationship between the selected initial group buy participant and the subsequent group buy participant;

assessing a degree of influence the selected initial group buy participant has on the subsequent group buy participant based on the relationship; and

varying the incentive offered to the selected initial group buy participant corresponding to the assessed degree of influence.

The embodiments described herein provide in a further aspect, a method of conducting electronic commerce at a server, the method comprising the server:

publishing an initial group buy offer;

receiving requests from a first plurality of group buy participants to participate in the initial group buy offer;

indicating the initial group buy offer is valid once a minimum threshold number of group buy participants is met;

receiving additional requests from a second plurality of group buy participants to participate in the initial group buy offer; and

offering an opportunity to participate in a second group buy offer if a total number of group buy participants comprising the first plurality and the second plurality exceeds a predetermined number.

### DRAWINGS

Various example embodiments of the present invention will now be described with reference to the drawings, in which:

FIG. 1 is a block diagram of a system for conducting electronic commerce by providing group buy offers, in accordance with an embodiment of the present disclosure;

FIG. 2 is a flowchart diagram illustrating the steps of conducting electronic commerce by providing group buy offers, in accordance with an embodiment of the present disclosure;

FIG. 3 is an example screenshot illustrating a published initial group buy offer;

FIG. 4 is an example screenshot illustrating an e-mail sharing an initial group buy offer;

FIG. 5 is an example screenshot illustrating a complete deal a group buy participant is currently receiving;

FIG. 6 is a flowchart diagram illustrating the steps of conducting electronic commerce by providing group buy offers, in accordance with another embodiment of the present disclosure; and

FIG. 7 is another example screenshot illustrating a published initial group buy offer.

### DESCRIPTION OF VARIOUS EMBODIMENTS

Merchants and/or service providers may desire to offer group buy offers as a way of promoting their business. Generally, merchants and service providers are more willing to provide greater discounts and more attractive offers when they are guaranteed a greater number of buyers than just a single buyer or a few buyers.

Since a group buy offer is valid only if the predefined threshold of buyers purchases the offer within the limited time period, buyers of the group buy offer may want to share the group buy offer with others to ensure that the group buy offer becomes valid. However, once the predefined threshold of buyers is met during the time period and the group buy offer becomes valid, group buy participants are no longer inclined to solicit for more buyers to join the group buy offer.

There is, thus, a need for improved systems and methods of conducting electronic commerce that provide group buy offers in a way that captures buyers beyond the minimum threshold of buyers.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor (e.g., a microprocessor), a data storage system (including volatile and non-volatile memory and/or storage elements), at least one input device, and at least one output device. For example and without limitation, the programmable computers (referred to below as computing devices) may be a personal computer, laptop, personal data assistant, cellular telephone, smart-phone device, tablet computer, and/or wireless device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Moreover, the subject system may be implemented as one or more software components stored on a computer server that is accessible via a client machine in a client-server architecture. In such case, the system can be considered to be a hosted software offering or a software service employed in a software-as-a-service deployment.

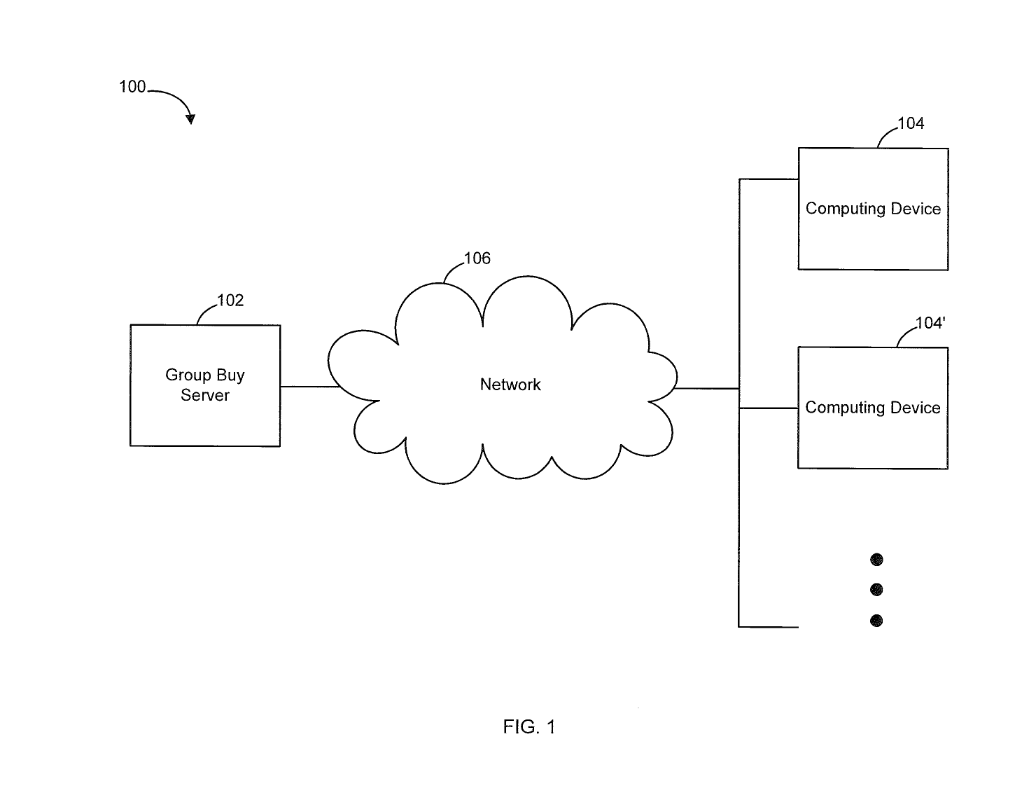

Referring to FIG. 1, a block diagram of a system 100 for conducting electronic commerce by providing group buy offers in accordance with an embodiment of the present disclosure. The system 100 includes a group buy server 102 and one or more computing devices 104, 104′, each connected to a network 106. It will be understood that the system 100 may be operable to communicate with one or more computing devices, and that the illustrated embodiment is merely an example and other configurations may be used.

Group buy server 102 may include a network interface for connecting to the network 106, for example, to communicate with the computing devices 104, 104′. Similarly, the system 100 and the computing devices 104, 104′ may each have a network interface for connecting to the network 106 to communicate with each other and/or the group buy server 102.

The group buy server 102 may include one or more processors with computing processing abilities and memory such as a database(s) or file system(s). Although only one group buy server 102 is shown for ease of exposition, there may be multiple group buy servers 102 distributed over a wide geographic area and connected via network 106.

Group buy server 102 may further include one or more databases (not shown) for storing information relating to, for example, group buy offers and group buy participants. In some embodiments, one database may be used to store this information. In some other embodiments, one database may be used to store, for example, information related to group buy offers (e.g., a group buy offer database) and another database may be used to store, for example, information related to group buy participants (e.g., a group buy participant database).

Information related to a group buy offer that may be stored in a database on the group buy server 102 may, for example, include a price, details about the offer, information about a merchant and/or service provider providing the group buy offer, a time period for which the group buy offer is available for purchase, a number of buyers required for the group buy offer to be valid (e.g., the minimum threshold), a current number of buyers, and a status information (e.g., whether the group buy offer is valid or not).

Information related to group buy participants that may be stored in a database on the group buy server 102 may, for example, include personal information (e.g., name, sex, age, birthdate, etc.), a login identifier and password for entering the group buy server (e.g., a group buy server login and password), contact information (e.g., e-mail addresses, home addresses, phone numbers, social network identifiers), and past purchases of group buy offers. Other personal information such as, for example, employer information, personal interests, hobbies and other similar information may also be stored. Also, a source identifier indicating how a group buy participant learned of group buy offers that the group buy participant purchased may also be stored in the database.

Additional information relating to the group buy participants that may be stored in the database may include how a group buy participant connects to the group buy server, such as, for example, one or more connection parameters indicating how a computing device 104, 104′ corresponding to the group buy participant accessed the group buy server 102.

Other example information related to group buy participants that may be stored in a database on the group buy server 102 may include how a group buy participant may relate to another group buy participant. For example, a first group buy participant may be a family member of a second group buy participant. In another example, one or more group buy participants may work for the same employer.

The network 106 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

In some embodiments, the network 106 may be any network which allows access to the group buy server 102 from remote locations outside of a Local Area Network (LAN) within which the group buy server 102 operates.

Each of the computing devices 104, 104′ may be any networked device operable to connect to the network 106. A networked device is a device capable of communicating with other devices through a network such as the network 106. A network device may couple to the network 106 through a wired or wireless connection.

As noted, these computing devices may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

In some embodiments, these computing devices may be a laptop 104, or a smartphone device 104′ equipped with a network adapter for connecting to the Internet. In some embodiments, the connection request initiated from the computing devices 104, 104′ may be initiated from a web browser and directed at the browser-based communications application (e.g., a web server such as Apache™) on the group buy server 102.

In one example embodiment, one or more incentives may be provided to a group buy participant for sharing a group buy offer with one or more subsequent group buy participants after the minimum threshold number of buyers is met. This may be done, for example, to capture buyers beyond the minimum threshold number of buyers.

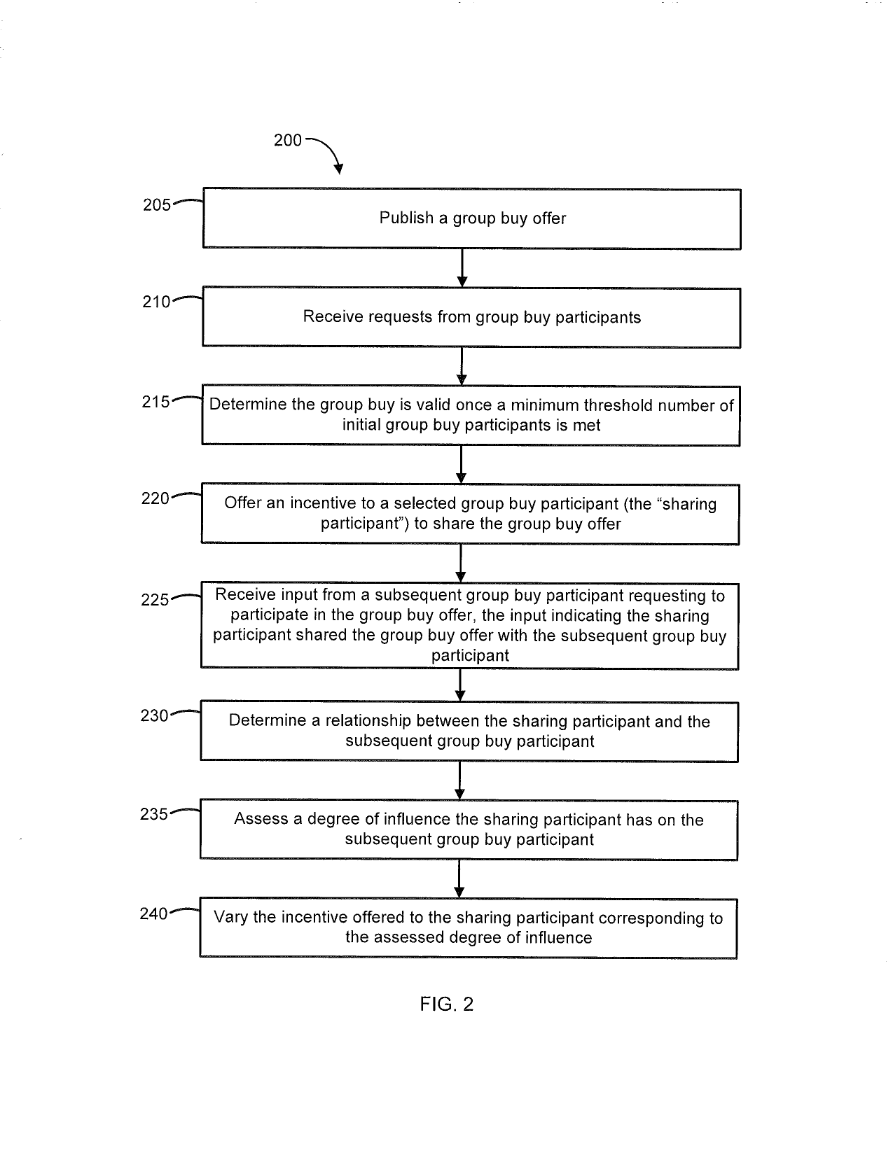

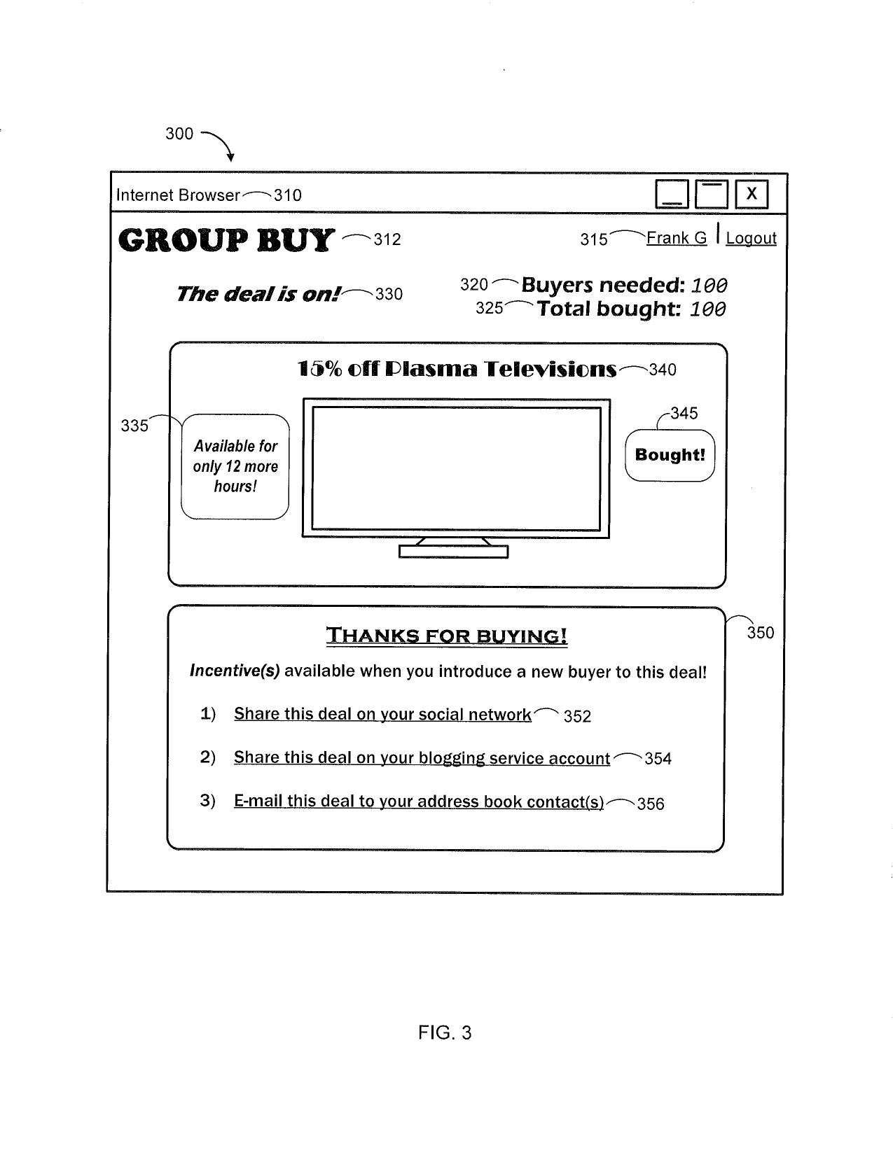

Referring to FIG. 2, illustrated therein generally as 200, is a flowchart diagram illustrating the steps of conducting electronic commerce by providing group buy offers with a group buy server 102, in accordance with an embodiment of the present disclosure. To illustrate the steps of the method, reference will be made simultaneously to FIGS. 3, 4 and 5, which illustrate an example screenshot of a published group buy offer at different stages.

At step 205, the group buy server 102 may publish an initial group buy offer by making the initial group buy offer accessible through the network 106.

As discussed, the group buy server 102 may include one or more databases for storing information relating to initial group buy offers and group buy participants. The group buy server 102 may publish an initial group buy offer by, for example, retrieving information associated with the initial group buy offer stored in the corresponding one or more databases, and making available the retrieved information associated with the initial group buy offer over the network 106 to the computing devices 104, 104′.

Referring simultaneously to FIG. 3, illustrated therein generally as 300, is an example screenshot illustrating a published initial group buy offer 312 in an internet browser 310. In the illustrated example, the initial group buy offer is published on an electronic webpage and accessed from the internet browser 310 of a computing device 104. It will be understood that publishing the initial group buy offer on the electronic webpage in the example screenshot 300 is merely an example, and that other publication methods may be used. It will also be understood that the example screenshot 300 is merely an example and other display configurations may be used when publishing the initial group buy offer.

For example, in one embodiment, the initial group buy offer may be published on an electronic webpage and accessed from an internet browser on the computing devices 104, 104′. In another embodiment, the initial group buy offer may be published through one or more smartphone applications and accessed from one or more smartphone devices 104, 104′.

At step 210, the group buy server 102 may receive a request to participate in the published initial group buy offer 312 from a computing device 104, 104′ associated with one or more group buy participants.

The request may include at least one connection parameter to indicate how the computing device 104, 104′ is accessing the group buy server 102. The group buy server 102 may store the at least one connection parameter in a database. In some embodiments, the connection parameter may be an Internet Protocol (IP) address. In other embodiments, the connection parameter may include the organization from which the connection is originating, or an asset tag of the device that is requesting the connection. In further embodiments, the connection parameter may include information about the type of connection used by the computing device 104, 104′. For example, a connection parameter may indicate whether the connection was performed via a wireless network, a mobile phone, or hardwired device.

Upon receipt of the request from the one or more group buy participants through the computing device 104, 104′, the group buy server 102 may request further information from the requesting one or more group buy participants. For example, if a requesting group buy participant is a new user to the group buy server 102, the requesting group buy participant may be required to register with the group buy server 102 by creating a user account for accessing the group buy server 102. In some embodiments, in order to create the user account, the group buy server 102 may request the group buy participant to provide personal information, such as name, sex, and/or contact information (e.g., e-mail addresses, home addresses, phone numbers, social network identifiers), and to select a group buy server login and a corresponding password. In some other embodiments, the group buy server 102 may request the group buy participant to provide an e-mail address, a social network identifier and/or a blogging account identifier. The group buy server 102 may then store the information provided by the group buy participants into one or more databases.

Alternatively, the requesting group buy participant may be a returning user to the group buy server 102. In some embodiments, the requesting group buy participant may purchase the initial group buy offer by logging into a user account on the group buy server 102 from the computing device 104, 104′ with a corresponding group buy server login identifier and password. In some embodiments, the group buy participant may purchase the initial group buy offer by accessing the group buy server 102 with an e-mail address that is stored in a database on the group buy server 102, a social network identifier that is stored in a database on the group buy server 102, and/or a blogging account identifier that is stored in a database on the group buy server 102.

In some embodiments, a user may log into the group buy server 102 to view an initial group buy offer. In some embodiments, a user may log into the group buy server 102 only if the user intends to purchase the initial group buy offer.

At step 215, the group buy server 102 determines the initial group buy offer is valid once a minimum threshold number of initial group buy participants is met.

As discussed, the group buy server 102 may include one or more databases for storing information regarding group buy offers, including a number of participants, or a minimum threshold of participants, required for a group buy offer to be valid and also, a current number of buyers of the group buy offer. The one or more databases on the group buy server 102 may also include a time period for which the group buy offer is available for purchase. In at least one embodiment, the group buy server 102 may determine if an initial group buy offer is valid within the time period by comparing the current number of buyers with the minimum threshold number of group buy participants for the initial group buy offer.

For example, if the current number of buyers is less than the minimum threshold number of participants of the initial group buy offer and there is time remaining to purchase the initial group buy offer, the initial group buy offer is not valid and requires more participants in order to become valid. Generally, the group buy server 102 may provide tools with which group buy participants may share the initial group buy offer with others. In some embodiments, the tools may include Uniform Resource Locator (URL) links that enable the group buy participants (e.g., the “sharing participant”) to directly share the initial group buy offer with people with whom they are connected, for example, on a social network (e.g., Facebook®, Google+™, Linkedln®, etc.), a blogging service (e.g., Blogger™ or a microblogging service such as Twitter™, etc.) and/or an electronic address book.

In another example, if the current number of buyers is equal or greater than the minimum threshold of participants for the initial group buy offer, the initial group buy offer is valid without requiring further participants to purchase the group buy offer. That is, when the minimum threshold of participants is met, the initial group buy offer is valid and there is no need for the group buy participants to share or to continue to share the group buy offer with others.

In some embodiments, the minimum threshold number of participants may be displayed on the published group buy offer 312. In some embodiments, the current number of buyers of a group buy offer may be displayed on the published group buy offer 312 and updated as the group buy server 102 receives more requests to participate in the group buy offer.

Referring again to FIG. 3, the example screenshot 300 illustrates an initial group buy offer that a group buy participant has purchased. In the illustrated example, the group buy participant is identified by a group buy user identifier 315 ‘Frank G.’. It will be understood that using a group buy user identifier to log into the group buy server 102 is merely an example, and that other user identifiers may be used to log into the group buy server 102, such as for example, an e-mail address, a social network identifier and/or a blogging account identifier.

As illustrated in FIG. 3, various details about the initial group buy offer may be provided on the published initial group buy offer 312, including a field 320 identifying a minimum threshold of buyers required for the offer to be valid, a field 325 identifying a current number of buyers, a field 330 displaying a status information, a field 335 displaying a remaining time period for which the offer is available for purchase, and a field 340 providing details about the initial group buy offer. The example screenshot 300 further includes a field 345 identifying whether the initial group buy offer has been purchased by the user associated with the group buy user identifier 315. It will be understood that these described fields are merely examples, and that fewer and/or additional fields may be provided on the initial published group buy offer 312. It will also be understood that the organization of the user display is merely an example, and that other display configurations may be used.

In the example screenshot 300, the example initial group buy offer is a discount of “15% off Plasma Televisions” 340. The minimum threshold number of buyers 320 required for the offer to be valid is 100 buyers and the current number of buyers 325 is 100 buyers. The group buy offer is, therefore, valid, as illustrated with the status field 330 (i.e., “The deal is on!”). Accordingly, all the purchasers of this initial group buy offer will be able to purchase the group buy offer. There is also time remaining to purchase the group buy offer, as illustrated by the remaining time period field 335 (i.e., “Available for 12 more hours!”) in this example embodiment.

Once the minimum threshold number of buyers 320 associated with the initial group buy offer is met, as with the example illustrated in FIG. 3, the initial group buy offer is valid and no further buyers are needed. Group buy participants are, therefore, less inclined to solicit for more buyers to join the group buy offer even if there is time remaining for purchasing the group buy offer.

At step 220, the group buy server 102 offers an incentive to a selected group buy participant (the “sharing participant”) to share the group buy offer with a new buyer.

Generally, an incentive may be considered to have one or more characteristics. For example, an incentive that is a free cappuccino from coffee shop may have at least the following characteristics: (i) that it is an offer from coffee shop, (ii) the name of the coffee shop and (iii) that it is a free cup of cappuccino. Similarly, an incentive that is a discount of 50% on a name brand DVD player from an electronics retailer may have at least the following characteristics: (i) the brand name of the DVD player, (ii) the name of the electronics retailer, and (iii) that it is a 50% discount.

In some embodiments, the group buy server 102 may reveal all the characteristics relating to an incentive to the sharing participant. In some embodiments, the group buy server 102 may conceal one or more characteristics relating to an incentive from the sharing participant until a person with whom the sharing participant shared the initial group buy offer also purchases the group buy offer. In further embodiments, the group buy server 102 may reveal an additional one or more characteristic(s) about the incentive to the sharing participant over a period of time.

In some embodiments, the incentive may be a bonus offer provided by a merchant offering the initial group buy offer. For example, the bonus offer may be a free product or service. In a further example, the bonus offer may be a free product or service related to the initial group buy offer. In another example, the bonus offer may be a rebate on the initial group buy offer.

In variant embodiments, the incentive may be an opportunity to participate in a second group buy offer. For example, the second group buy offer may be provided by a merchant or service provider providing the initial group buy offer. In another example, the second group buy offer may be for a product or service related to the initial group buy offer.

In some embodiments, the group buy server 102 may provide one or more incentives to a group buy participant, and the one or more incentives may be the same or different incentives.

In some embodiments, the published initial group buy offer 312 may include a control box field 350. The control box field 350 may indicate to the group buy participant (the “sharing participant”) that one or more incentives is available if the sharing participant shares the initial group buy offer with a new buyer. In some embodiments, the group buy server 102 may include on the published initial group buy offer 312, such as for example in the control box field 350, one or more Uniform Resource Locator (URL) links for facilitating the sharing of the initial group buy offer by the sharing participant.

Referring again to FIG. 3, a user is illustrated as being logged into the group buy server 102 with the group buy user identifier 315 ‘Frank G’. As illustrated by the field 345 indicating whether the logged-in user has purchased the deal (i.e., “Bought!”), the user Frank G. is already a group buy participant to the initial group buy offer shown in the example screenshot 300. Since the minimum threshold number of buyers 320 is met and there is time remaining for purchasing the initial group buy offer 335 (i.e., “Available for only 12 more hours!”), the group buy server 102 indicates to Frank G. (the “sharing participant”), in the control box field 350, that further incentives are available if he shares the initial group buy offer with one or more new buyers to the initial group buy offer. In the control box field 350 in the example screenshot 300, the group buy server 102 provides the sharing participant, for example, Frank G., with URL links for sharing the initial group buy offer. The URL links may be for accessing any one of a social network 352 and a blogging service 354, and for sending an e-mail 356 to one or more contacts in an electronic address book.

Continuing with this example, the user Frank G. may decide to e-mail this deal using the email link 356.

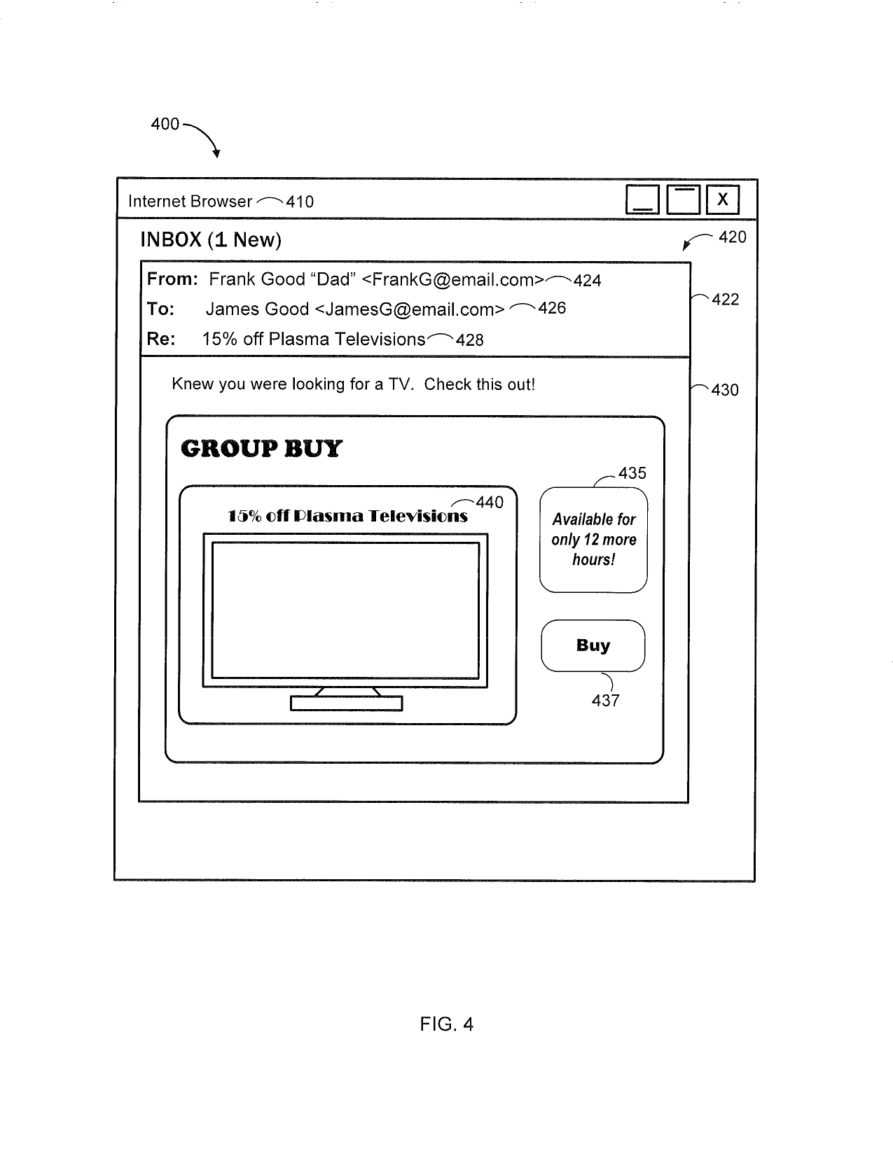

Referring to FIG. 4, illustrated therein generally as 400, is an example screenshot illustrating an e-mail 420, in an internet browser 410, sharing an initial group buy offer. The e-mail 420 generally includes at least a header section 422 and a body section 430. It will be understood that the displayed configuration of the e-mail 420 is merely for illustration, and that other display configurations may be possible.

In the header section 422 of the e-mail 420, various fields identifying a sender (the “sharing participant”) 424, a recipient 426 and a subject 428 are provided. In the sender field 424 of the example screenshot 400, the sender (the “sharing participant”) is identified as ‘Frank Good’ and is associated with an e-mail address, ‘FrankG@email.com’. In the recipient field 426 of the example screenshot 400, the recipient (the potential or subsequent group buy participant) is identified as ‘James Good’ and is associated with an e-mail address, ‘JamesG@email.com’. It will be understood that the recipient field 426 may include one or more recipients. The subject field 428 of the example screenshot 400 includes a description of the initial group buy offer, that is, a discount of ‘15% off Plasma Televisions’. It is to be understood that the subject field 428 of the e-mail 420 may or may not include a description of the initial group buy offer.

Information about the initial group buy offer may be provided in the body section 430 of the e-mail 420. For example, similar to the published initial group buy offer 312 in FIG. 3, a field 440 providing details about the initial group buy offer and a field 435 displaying a remaining time period for which the initial group buy offer is available for purchase may be provided. It will be understood that other fields may be provided in the e-mail and that the example fields are merely for illustration purposes.

For purposes of illustration, the example screenshot 400 illustrates an initial group buy offer consistent with the example screenshot 300 in FIG. 3. Accordingly, the information about the initial group buy offer is the same in FIGS. 3 and 4, that is, the field 440 displaying details of the initial group buy offer (i.e., a discount of ‘15% off Plasma Televisions’) and the field 435 displaying a remaining time period (i.e., ‘Available for only 12 more hours!’) include the same content.

In some embodiments, the e-mail 420 may include a control 437 that may receive input from the user to indicate that they desire to buy into the initial group buy offer. For example, the control 437 may be a button and/or a URL link. In the example screenshot 400, a button (e.g., a ‘Buy’ button) 437 is provided in the body section 430 for redirecting the recipient of the e-mail to a published initial group buy offer 312 for purchasing the initial group buy offer.

In some embodiments, if the sharing participant chooses to share the initial group buy offer via their account on a blogging service 354 (e.g., a microblogging service such as Twitter™), a URL link to the published initial group buy offer 312 may be provided as part of a blog post or an update message (e.g., a Tweet on the Twitter™ microblogging service) and the sharing participant's readers or microblogging followers may access the initial group buy offer with the provided URL link.

In some embodiments, if the sharing participant shares the initial group buy offer on a social network 352, a URL link to the published initial group buy offer 312 may be provided on a status update associated with the sharing participant and/or a message including the URL link may be sent to one or more of members of the social network connected to the sharing participant. All members of the social network who are connected to the sharing participant may then purchase the initial group buy offer using the URL link.

Although sending an e-mail, sharing on a social network and/or sharing on a blogging service are discussed, it will be understood that these methods of sharing an initial group buy offer may be used in various combination. It will also be understood that these methods are provided for illustration purposes only, and that other mechanisms of sharing an initial group buy offer (e.g., instant messaging) may be possible. It will also be understood that when sharing deals via these methods, the system may be redirected to a log-in screen for these various sharing mechanisms to allow a user to log-in to their user accounts for the selected sharing mechanism (unless the system registers the user as already having logged-in).

At step 225, the group buy server 102 receives an input from a subsequent group buy participant, who is not already a group buy participant, requesting to participate in the initial group buy offer and the input indicates that the sharing participant shared the initial group buy offer with the subsequent group buy participant.

When an individual with whom the sharing participant shared the initial group buy offer decides to purchase the initial group buy offer, the individual may use any of the provided controls (e.g., a button and/or URL links) to send a request to the group buy server to access the published initial group buy offer 312. This request may be received as an input to the group buy server. The input may include a source identifier for indicating how the initial group buy offer was shared with the individual. The source identifier may include a personal identifier indicating an identity of the sharing participant and how the sharing participant shared the initial group buy offer with the individual (e.g., through a social network, a blogging service or an e-mail). The group buy server 102 may also store the personal identifier and source identifier in a database.

For example, referring again to FIG. 4, when the recipient, James Good, selects the click button (‘Buy’) 437, the group buy server 102 receives an input indicating the request to access the published initial group buy offer 312. The input may also include a source identifier. The source identifier may include information indicating the identity of the sharing participant (i.e., Frank Good). The sharing participant may be identified in the input by any of personal identifier such as a corresponding e-mail address (i.e., “FrankG@email.com”), name (“Frank Good”) and/or group buy server login identifier 315 (“Frank G”). The source identifier may also include a personal identifier indicating that Frank G. shared the initial group buy offer with James G. using an e-mail. For example, the personal identifier may be an electronic address book identifier, such as the e-mail address associated with Frank G. (i.e., “FrankG@email.com”). Alternatively, if the sharing participant used the contacts stored in the electronic address book of a Blackberry® device, the electronic address book identifier may be a Personal Identification Number (PIN) such as a Blackberry® PIN corresponding to the Blackberry® device. In some embodiments, the source identifier (which may include the personal identifier) may be embedded in the URL that directs the receiver of the initial group buy offer (e.g., James Good in the illustrated example) to the group buy server 102.

In some embodiments, the sharing participant may share the initial group buy offer on a social network 352 by providing a URL link to the published initial group buy offer 312. The URL link may be associated with a source identifier. When an individual from the sharing participant's social network selects the URL link from the computing device, an input is provided to the group buy server 102 and the input may include a source identifier. As with the above example describing sharing the initial group buy offer with an e-mail, the source identifier may similarly include an identity of the sharing participant and an identifier indicating how the sharing participant shared the initial group buy offer with the individual (i.e., a social network identifier associated with the sharing participant).

In some embodiments, the sharing participant may share the initial group buy offer via their account on a blogging service 354 by providing a URL link to the published initial group buy offer 312. The URL link may be associated with a source identifier. When a blog reader or microblogging follower selects the URL link from the computing device, an input is provided to the group buy server 102 and the input may include a source identifier. As with the above example describing sharing the initial group buy offer with an e-mail, the source identifier may similarly include an identity of the sharing participant and an identifier indicating how the sharing participant shared the initial group buy offer with the individual (i.e., a blogging service identifier associated with the sharing participant).

Similar to the above discussion in relation to step 210, upon receipt of the input from the one or more subsequent group buy participants from the computing device 104, 104′, the group buy server 102 may request for further information from the one or more subsequent group buy participants.

For example, if a subsequent group buy participant is a new user to the group buy server 102, the requesting group buy participant may be required to create a user account corresponding to the group buy server 102. In some embodiments, in order to create the user account, the group buy server 102 may request the subsequent group buy participant to provide one or more personal data elements, such as name, sex, and/or contact information (e.g., e-mail addresses, home addresses, phone numbers, social network identifiers), and to select a group buy server login and a corresponding password. In some other embodiments, the group buy server 102 may request the subsequent group buy participant to provide an e-mail address, a social network identifier and/or a blogging account identifier. The group buy server 102 may then store the information provided by the subsequent group buy participants into one or more databases.

Alternatively, the subsequent group buy participant may be a returning user to the group buy server 102. In some embodiments, the subsequent group buy participant may purchase the initial group buy offer by logging into the group buy server 102 from the computing device 104, 104′ with a group buy server login and password. In some embodiments, the subsequent group buy participant may purchase the initial group buy offer by accessing the group buy server 102 with an e-mail address that is stored in a database on the group buy server 102, a social network identifier that is stored in a database on the group buy server 102, and/or a blogging account identifier that is stored in a database on the group buy server 102.

At step 230, the group buy server 102 determines a relationship between the sharing participant and the subsequent group buy participant. The group buy server 102 may determine the relationship between the sharing participant and any one or more subsequent group buy participants with one or more relationship indicators.

In some embodiments, these relationship indicators may include a source identifier indicating how the sharing participant shared the initial group buy offer with any of the one or more subsequent group buy participants.

For example, if the source identifier indicates that the sharing participant shared the initial group buy offer with the subsequent group buy participant through a social network, such as Facebook®, the group buy server 102 may determine that the relationship between the sharing participant and the subsequent group buy participant to be close because they may be friends. In some embodiments, the type of social network may also be taken into account when determining the type of relationship. For example, if the social network was a professionals network (e.g., Linkedln®), then the group buy server 102 may determine that the relationship may not be close because the sharing participant and the subsequent group buy participant have not worked together in many years, for example.

In another example, if the source identifier indicates that the sharing participant shared the initial group buy offer with the subsequent group buy participant through a blogging service, such as Twitter™, the group buy server 102 may determine that the relationship between the sharing participant and the subsequent group buy participant may not be close, that is, they may be strangers (i.e., the sharing participant is a celebrity whereas the subsequent group buy participant is a fan).

In some embodiments, these relationship indicators may include one or more personal data elements associated with the subsequent group buy participant. These personal data elements may include personal information provided by the subsequent group buy participant on request from the group buy server 102 and thus, can be retrieved from a relevant database on the group buy server 102.

Referring to FIG. 4, as illustrated in each of the sender field 424 and the recipient field 426, the sender “Frank Good” and the recipient “James Good” share a surname. The surname of the subsequent group buy participant may be a relationship indicator.

In variant embodiments, the personal data elements may be retrieved from one or more user accounts on a social network, blogging service, and/or electronic address book associated with the subsequent group buy participant.

For example, a relationship between the sharing participant and one or more subsequent group buy participant may be determined from contents of an electronic address book associated with the e-mail addresses of any of the sender and/or recipient. Referring still to FIG. 4, the sharing participant, Frank G., is indicated as being the father of the recipient in the sender field 424. This relationship may be determined from how the sharing participant's e-mail is stored in the electronic address book associated with the recipient's e-mail address, or alternatively, how the recipient's e-mail is stored in the electronic address book associated with the sharing participant's e-mail address. Similar information may be retrieved from the user accounts on a social network and/or blogging service corresponding to the subsequent group buy participant.

At step 235, the group buy server 102 assesses a degree of influence the sharing participant has on the subsequent group buy participant based on the relationship determined at step 230.

The degree of influence that a sharing participant has on a subsequent group buy participant to influence the subsequent group buy participant to purchase an initial group buy offer may be dependent on various factors. For example, the sharing participant may have a greater degree of influence over a potential group buy participant if the sharing participant and the potential group buy participant are from the same family. However, a sharing participant may have varying degrees of influence over the potential group buy participant depending on how closely related they are. For example, siblings may have greater influence over each other than cousins have over each other.

Similarly, individuals connected over a social network may have a stronger degree of influence over each other than individuals connected through a blogging service. For example, individuals connected on a social network may be more mutually connected, that is, they may be friends or co-workers, whereas individuals on a blogging service may have less of a mutual, two-way connection: for example, a fan may be a microblogging follower of a celebrity, or a stranger may be a reader of a blog due to similar interests without the reader having a personal connection with the blog creator.

The degree of influence may be assessed, for example, by associating a score with each relationship indicator and calculating a final score based on the score associated with each relationship indicator. The score associated with each relationship indicator may be selected from any range of numerals, such as for example 1 to 10. Alternatively, the score may be a decimal value selected from a range from 0 to 1. It will be understood that these described ranges are merely examples, and other ranges may be used.

For example, a relationship indicator may be a source indicator, that is, how a sharing participant shared the initial group buy offer with a subsequent group buy participant. As discussed above, the source indicator may include an e-mail address, a social network identifier and/or a blogging service identifier. A relationship indicator such as an e-mail address may be associated with a higher score since a sharing participant who knows an e-mail address associated with a subsequent group buy participant may be considered to have a higher degree of influence over the subsequent group buy participant. A relationship indicator such as a blogging service identifier may be associated with a lower score since a sharing participant who shares the initial group buy offer on the blogging service may potentially be sharing the initial group buy offer with strangers since a blogging service is generally more directed to the public.

In another example, referring still to FIG. 4, a relationship indicator such as a common surname (i.e., “Good”) between the sharing participant and the subsequent group buy participant may indicate that they are relatives and thus, a higher score may be associated with this relationship indicator because a relative may have a greater degree of influence over each other. Another relationship indicator may be determined from an electronic address book. For example, in the example screenshot 400, Frank Good's contact information, as provided in an electronic address book associated with Frank Good's e-mail address and/or James Good's e-mail address, includes an indication that Frank Good is the father of James Good. This relationship indicator may be associated with a higher score since a father is likely to have a greater degree of influence over a son.

After associating a score with each relationship indicator, the group buy server 102 may calculate a final score. In some embodiments, the group buy server 102 may calculate a final score by determining an average of the scores associated with each relationship indicator. In some variant embodiments, the group buy server 102 may calculate a final score by determining a sum of the scores associated with each relationship indicator. In some further embodiments, the group buy server 102 may calculate a final score by determining a weighted average of the scores associated with each relationship indicator. The weighted average may involve assigning a numeric weight to each of the relationship indicators to indicate how relevant each relationship indicator is in assessing a degree of influence.

In some embodiments, the number of relationship indicators between the sharing participant and the subsequent group buy participant may be an additional factor in assessing the degree of influence. For example, if a sharing participant is connected with the subsequent group buy participant via both a social network and a blogging service (as may be determined, for example, by analyzing how group buy offers have been shared between the sharing participant and the subsequent group buy participant in the past), the system may determine that there may be a larger degree of influence because the sharing participant may be able to influence the subsequent group buy participant via multiple sharing mechanisms.

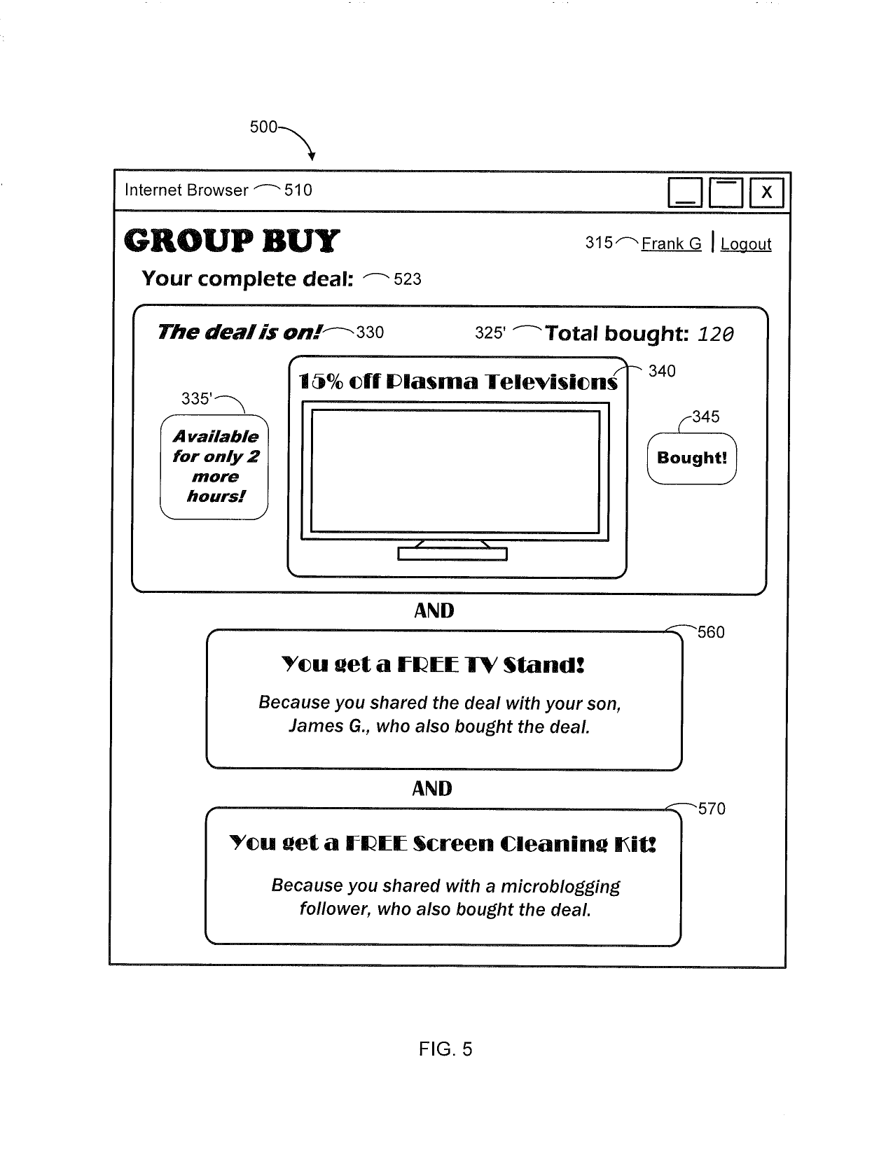

Referring to FIG. 5, illustrated therein generally as 500, is an example screenshot illustrating, in an internet browser 510, a complete deal 523 a group buy participant is currently receiving.

In the example screenshot 500, the complete deal 523 that the group buy participant is currently receiving is illustrated. The complete deal 523 includes the published initial group buy offer 312 that the group buy participant purchased and any one or more incentives 560, 570 the group buy participant received for sharing the published initial group buy offer 312 with one or more subsequent group buy participants.

For purposes of illustration, the example screenshot 500 illustrates a published initial group buy offer 312 purchased by a user identified by the group buy user identifier 315 ‘Frank G.’ as was shown earlier with the example screenshot 300. Accordingly, in each of FIGS. 3 and 5, some fields remain the same at all times, for example, the details of the initial group buy offer field 340 (i.e., a discount of ‘15% off Plasma Televisions’) and the status field 330 (i.e., “The deal is on!”), and the field 345 indicating whether the user bought the initial group buy offer (i.e., “Bought!”). Other fields related to the published initial group buy offer are updated over time, such as the field identifying a current number of buyers 325′ at a later time from the corresponding field 325 in FIG. 3 and the field displaying a remaining time period for which the offer is available for purchase 335′ at a later time from the corresponding field 335 in FIG. 3.

The example screenshot 500 further illustrates incentives 560, 570 that the sharing participant, Frank G., received for sharing the published initial group buy offer 312 with one or more subsequent group buy participants.

At step 240, the group buy server 102 varies the incentive offered to the sharing participant corresponding to the assessed degree of influence.

In an example in which the incentive is an additional product offered to the sharing participant for free, the type or value of the free product may be varied in accordance with the assessed degree of influence the sharing participant has over the subsequent group buy participant (e.g., the value of the additional product may increase as the assessed degree of influence increases). As illustrated at 560, the sharing participant received an incentive (i.e., a free TV stand) for sharing the published initial group buy offer 312 with his son, James G., who also bought the published initial group buy offer 312. Similarly, at 570, the sharing participant received an incentive (i.e., a free screen cleaning kit) for sharing the published initial group buy offer 312 with a microblogging follower, who also bought the published initial group buy offer 312.

As previously discussed, the assessed degree of influence the sharing participant (the father) has over a subsequent group buy participant who is his son is likely higher than the degree of influence the sharing participant has over a microblogging follower who may be a stranger. Each of the incentives 560 and 570 for each corresponding subsequent group buy participant is therefore varied according to the assessed degree of influence. The incentive 560 provided to the sharing participant after sharing the initial group buy offer with his son who also purchases the initial group buy offer is therefore greater due to the higher assessed degree of influence. Conversely, the incentive 570 provided to the sharing participant after sharing the initial group buy offer with a microblogging follower who also purchases the offer is therefore less attractive due to the lower assessed degree of influence.

In some embodiments, an incentive may be varied based on a social value of the subsequent group buy participant. The social value of the subsequent group buy participant may be determined from a potential of the subsequent group buy participant to attract new group buy participants to the initial group buy offer.

In some variant embodiments, the potential for the subsequent group buy participant to attract new group buy participants may be based on a total number of connections the subsequent group buy participant has on a social network. For example, if the subsequent group buy participant has a large number of friends on the Facebook® social network, a corresponding social value may be high because the subsequent group buy participant has a large number of individuals with whom to share the initial group buy offer and thus, a greater potential to attract one or more further group buy participants to the initial group buy offer. In another example, if the subsequent group buy participant has only one small circle of friends on the Google+™ social network, a corresponding social value may be low because the subsequent group buy participant has a limited number of individuals with whom to share the initial group buy offer and thus, a smaller potential to attract one or more further group buy participants to the initial group buy offer.

In some embodiments, the potential for the subsequent group buy participant to attract new group buy participants to the initial group buy offer may be based on a total number of entries stored in an electronic address book corresponding to an electronic address book identifier associated with the subsequent group buy participant. The electronic address book identifier may be an e-mail address and/or a Blackberry® PIN associated with a Blackberry device on which an electronic address book may be stored. For example, a subsequent group buy participant has a higher social value if there is a large number of entries stored in an electronic address book corresponding to an e-mail address associated with the subsequent group buy participant.

For purpose of clarity in illustration, only two incentives are shown in this example embodiment. It will be understood that in some embodiments, any number of fewer or more incentives that the group buy server 102 makes available may be received by the sharing participant.

By varying the incentive offered to the sharing participant correspondingly with the assessed degree of influence, a group buy participant may be motivated to share the initial group buy offer with individuals who the sharing participant is likely to have closer connections with. From the merchant's perspective, such sharing is more likely to result in actual sales because the individual who received the deal is more likely to decide to make a purchase if they received it from a source that is close to them. Accordingly, such sharing mechanisms may result in increased sales for merchants.

In a further embodiment for conducting electronic commerce for providing initial group buy offers for capturing buyers beyond the minimum threshold number of buyers, an opportunity to purchase a second group buy offer may be available if a predetermined number of group buy participants purchases the initial group buy offer.

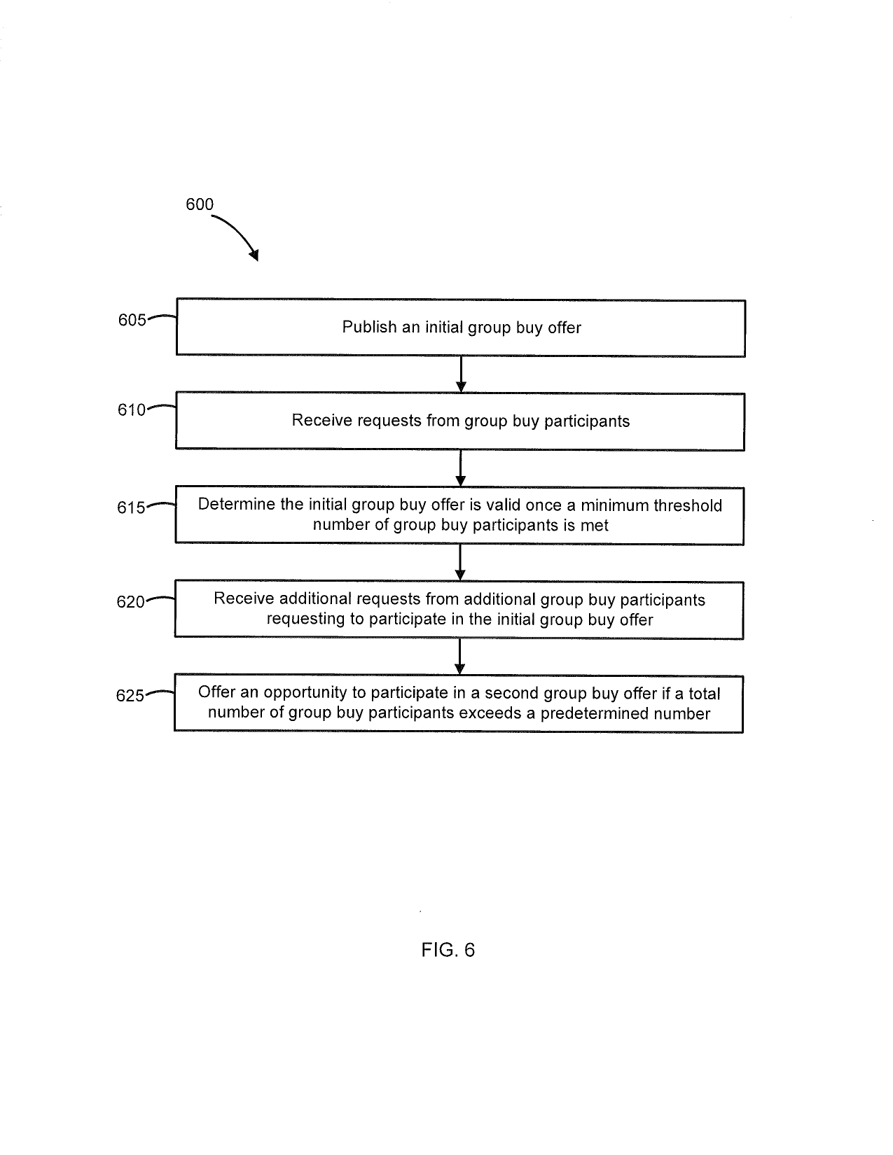

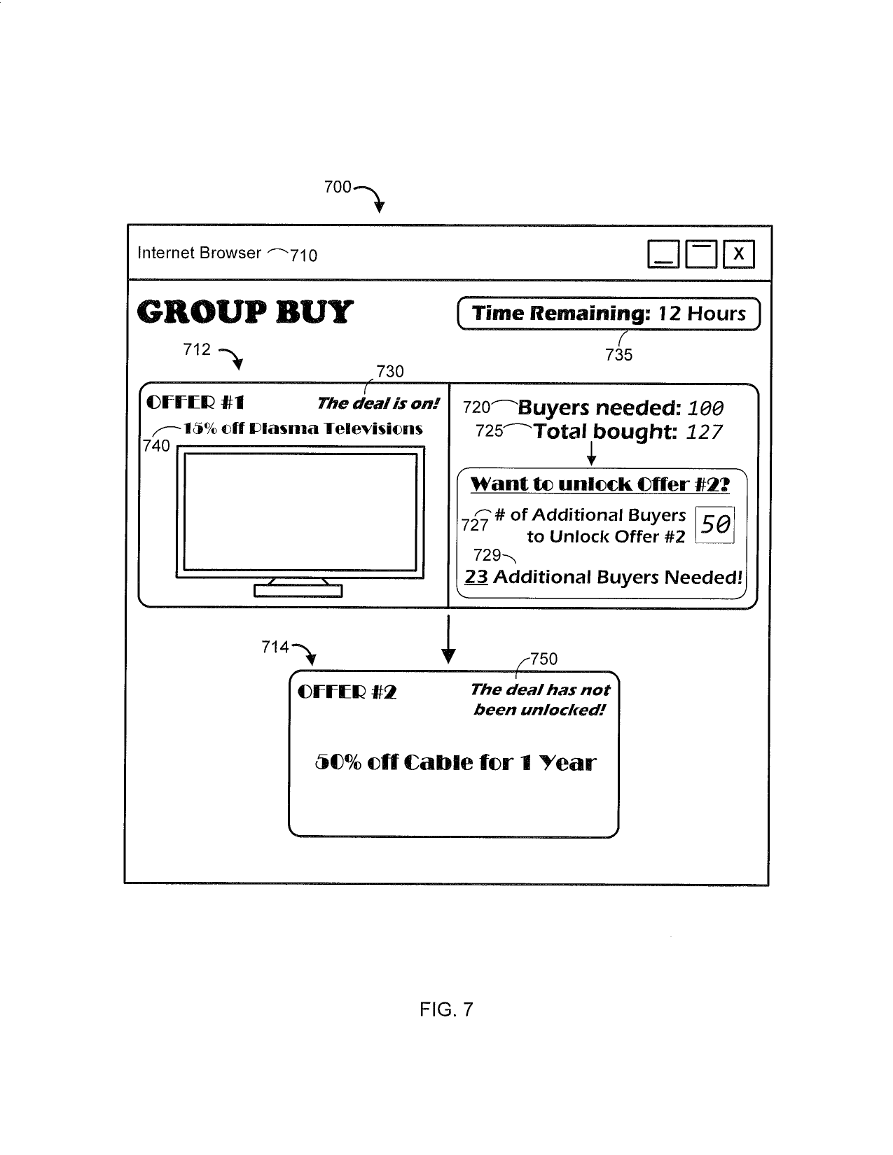

Referring to FIG. 6, illustrated therein generally as 600, is a flowchart diagram illustrating the steps of conducting electronic commerce by providing group buy offers by the group buy server 102, in accordance with another embodiment of the present disclosure. To illustrate the steps of the method, reference will be made simultaneously to FIG. 7, which shows another example of a published initial group buy offer.

At step 605, the group buy server 102 publishes an initial group buy offer. The initial group buy offer may be published similar to how step 205 of FIG. 2 is described above. Specifically, the group buy server 102 may publish an initial group buy offer by, for example, retrieving data associated with the initial group buy offer from a relevant one or more databases, and making available the retrieved data associated with the initial group buy offer over the network to the computing devices 104, 104′.

In one embodiment, the initial group buy offer may be published on an electronic webpage and accessed with an internet browser on the computing devices 104, 104′. In another embodiment, the initial group buy offer may be published through one or more smartphone applications and accessed on a smartphone device 104, 104′.

Referring to FIG. 7, illustrated therein generally as 700, is an example screenshot illustrating a published initial group buy offer 712 (i.e., Offer #1). In the illustrated example, the initial group buy offer is published on an electronic webpage and accessed from an internet browser 710. It will be understood that publishing the initial group buy offer on the electronic webpage in the example screenshot 700 is merely an example, and that other publication methods may be used. It will also be understood that the example screenshot 700 is merely an example and other display configurations may be used when publishing the initial group buy offer.

As illustrated in FIG. 7, various details about the initial group buy offer may be provided on a published initial group buy offer 712, including a field 720 identifying a minimum threshold of buyers required for the offer to be valid, a field 725 identifying a current number of buyers, a field 730 displaying a status information, a field 735 displaying a remaining time period for which the offer is available for purchase, and a field 740 providing details about the initial group buy offer.

At step 610, the group buy server 102 receives requests from group buy participants to participate in the initial group buy offer. The requests may be received from one or more group buy participants, that is, a first plurality of group buy participants, similar to how step 210 of FIG. 2 was described above.

The request may include at least one connection parameter to indicate how the computing device 104, 104′ is accessing the group buy server 102. The group buy server 102 may store the at least one connection parameter in a database. In some embodiments, the connection parameter may be an Internet Protocol (IP) address. In other embodiments, the connection parameter may include the organization from which the connection is originating, or an asset tag of the device that is requesting the connection. In further embodiments, the connection parameter may include information about the type of connection used by the computing device 104, 104′. For example, a connection parameter may indicate whether the connection was performed via a wireless network, a mobile phone, or hardwired device.

Upon receipt of the request from the one or more group buy participants through the computing device 104, 104′, the group buy server 102 may request for further information from the requesting one or more group buy participants. For example, if a requesting group buy participant is a new user to the group buy server 102, the requesting group buy participant may be required to register with the group buy server 102 by creating a user account for accessing the group buy server 102. In some embodiments, in order to create the user account, the group buy server 102 may request the group buy participant to provide personal information, such as name, sex, and/or contact information (e.g., e-mail addresses, home addresses, phone numbers, social network identifiers), and to select a group buy server login and a corresponding password. In some other embodiments, the group buy server 102 may request the group buy participant to provide an e-mail address, a social network identifier and/or a blogging account identifier. Other personal information such as for example employer information, personal interests, hobbies and other similar information may be provided. The group buy server 102 may then store the information provided by the group buy participants into one or more databases.

Alternatively, the requesting group buy participant may be a returning user to the group buy server 102. In some embodiments, the requesting group buy participant may purchase the initial group buy offer by logging into a user account on the group buy server 102 from the computing device 104, 104′ with a corresponding group buy server login identifier and password. In some embodiments, the group buy participant may purchase the initial group buy offer by accessing the group buy server 102 with an e-mail address that is stored in a database on the group buy server 102, a social network identifier that is stored in a database on the group buy server 102, and/or a blogging account identifier that is stored in a database on the group buy server 102.

In some embodiments, a user may log into the group buy server 102 to view an initial group buy offer. In some embodiments, a user may log into the group buy server 102 only if the user intends to purchase the initial group buy offer.

At step 615, the group buy server 102 indicates that the initial group buy offer is valid once a minimum threshold number of group buy participants is met. The group buy server 102 may determine a group buy offer is valid similar to how step 215 of FIG. 2 was described above.

Referring again to FIG. 7, in the example screenshot 700, the example initial group buy offer is a discount of “15% off Plasma Televisions” 740. The minimum threshold number of buyers 720 required for the offer to be valid is 100 buyers and the current number of buyers 725 is 127 buyers. The initial group buy offer is valid, as shown in the field 730 (i.e., “The deal is on!”). Accordingly, all the buyers will receive this initial group buy offer 712 (i.e., Offer #1). The remaining time period for purchasing the offer is also displayed 735 (i.e., twelve hours remains) in this example embodiment.

Once the minimum threshold of buyers 720 associated with the initial group buy offer 712 has been reached, as with the example screenshot 700, no further buyers are needed for the initial group buy offer to be valid and thus, group buy participants are less motivated to solicit for more buyers to join the initial group buy offer even if there is time remaining for purchasing the initial group buy offer.

In order to encourage these group buy participants to continue to solicit more participants to the initial group buy offer 712, an opportunity to participate in a second group buy offer 714 (i.e., Offer #2) may be available if a predetermined total number of buyers participate in the initial group buy offer 712 (i.e., Offer #1). The predetermined total number of buyers is a combined total of the total number of buyers required for Offer #1 to be valid 720 and the total number of additional buyers 727 needed to unlock Offer #2.

For example, referring still to FIG. 7, if the group buy participants 725 for Offer #1 712 want the opportunity to purchase Offer #2 714 (that is, to ‘unlock’ Offer #2), a predetermined number of buyers to Offer #1 is required. As illustrated in the example screenshot 700, the number of buyers 720 needed for Offer #1 to be valid is 100 buyers and the additional number of buyers 727 needed to unlock Offer #2 is 50 buyers. The predetermined total number of buyers of Offer #1 is therefore 150 buyers. Since the current number of buyers 725 of Offer #1 is 127 buyers, Offer #1 still needs to be purchased by 23 additional buyers 729 in order to unlock Offer #2. Offer #2 714 has, therefore, not been unlocked as illustrated with a second status field 750 (i.e., “The deal has not been unlocked!”) corresponding to the second group buy offer 714.

In some embodiments, instead of the Offer #2 being an opportunity to purchase a second group buy offer, the Offer #2 may be a free bonus item or additional discounts provided to the existing group of group buy participants. As compared to such embodiments, an opportunity to purchase a second group buy offer may be advantageous for the merchant because the merchant may be able to make additional sales with the second group buy offer (whereas in the case where the merchant is offering free bonus items or additional discounts, the merchant is not receiving any additional revenue with each new group buy participant).

At step 620, the group buy server 102 receives additional requests from additional group buy participants to participate in the initial group buy offer 712 (i.e., Offer #1). After the minimum threshold number of group buy participants is met, the group buy server 102 may continue to accept requests from additional group buy participants, that is, a second plurality of group buy participants, to participate in the initial group buy offer. The requests may be received from the second plurality of group buy participants similar to how requests from the first plurality of group buy participants were received by the group buy server 102 at step 610 described above.

As requests are received from these additional group buy participants, the group buy server 102 updates the fields displaying the total number of buyers 725 of Offer #1 and the number of additional buyers 729 needed to unlock Offer #2 accordingly.

At step 625, the group buy server 102 offers an opportunity to participate in a second group buy offer if a total number of group buy participants exceeds a predetermined total number of buyers.

Referring still to FIG. 7, if the total number of buyers 725 to Offer #1 is equal or greater than the predetermined number of buyers, Offer #2 has been unlocked and is available for purchase. Put another way, Offer #2 is unlocked and available for purchase if the number of additional buyers 729 needed to unlock Offer #2 becomes zero within the time remaining 735 for purchasing Offer #1.

In some embodiments, the opportunity to participate in the second group buy offer 714 is available only to the group buy participants within the minimum threshold of buyers 720, that is, the first plurality of group buy participants. For example, in the example screenshot 700, only the first 100 group buy participants may participate in the second group buy because the minimum threshold of buyers 720 required for Offer #1 to be valid is 100 buyers.

Similar to the initial group buy offer 712, the second group buy offer 714 generally includes one or more characteristics. For example, the second group buy offer 714 may be a discount of 50% off cable for 1 year. In such embodiment, one characteristic of the second group offer may be that it is a discount of 50%; another characteristic may be that it is for cable; and a further characteristic may be that the discount is for 1 year.

In some embodiments, the group buy server 102 may conceal one or more characteristics relating to the second group buy offer 714 until the total number of buyers 725 to Offer #1 is equal or greater than the predetermined number of buyers, that is, until Offer #2 714 has been unlocked.

In some embodiments, the group buy server 102 may conceal one or more characteristics relating to the second group buy offer 714 until a certain total number of buyers within the minimum threshold number of buyers 720 is reached. In a further embodiment, the group buy server 102 may establish one or more tiers of group buy participants. Each tier includes a number of additional group buy participants fewer than the minimum threshold number of buyers 720, that is, the first plurality of group buy participants. As each tier is met, the group buy server 102 may reveal one or more characteristics relating to the second group buy offer to the group buy participants.

For example, referring still to FIG. 7, since the minimum threshold number of buyers 720 required for Offer #1 to be valid is 100 buyers, the group buy server 102 may establish 3 tiers such that the first tier includes 30 buyers, the second tier includes 40 buyers and the third tier includes 10 buyers. So, as each tier is met, one additional characteristic relating to the second group buy offer 714 may be revealed. For example, after the first tier is met, the group buy server 102 may reveal that the second group buy offer 714 is a discount of 50%; after the second tier is met, the group buy server 102 may reveal that the second group buy offer 714 is for cable; and after the third tier is met, the group buy server 102 may reveal that the second group buy offer 714 provides the discount for 1 year. It will be understood that any number of tiers may be should as long as each tier includes at least one buyer. It will further be understood that one or more characteristics may be revealed at each tier.

In some further embodiments, the second group buy offer 714 may be customized based on one or more personal data elements associated with group buy participants. These personal data elements may include personal information provided by the group buy participants on request from the group buy server 102 as described above in relation to steps 610 and 620 and thus, may be retrieved from a corresponding database on the group buy server 102. Alternatively, the personal data elements may be retrieved from one or more user accounts on a social network, blogging service, and/or electronic address book associated with any one of the group buy participants.

In one embodiment, the group buy server 102 may customize a second group buy offer for each one of the group buy participants based on personal data elements associated with the corresponding group buy participant. For example, if one or more personal data elements stored on a database on the group buy server 102 indicate that one of the group buy participants is a female who practices yoga as a hobby, the group buy server may customize a second group buy offer that may be a discount on an instructional set of yoga DVDs for this group buy participant.

In another embodiment, the group buy server 102 may customize a second group buy offer for a subset of group buy participants who share similar one or more personal data elements. In one embodiment, the group buy server 102 may identify this subset of group buy participants by analyzing the data in one or more of its databases. For example, if a subset of the total number of group buy participants consists of male participants with golf as a hobby, the group buy server 102 may customize a second group buy offer consisting of a discount on a video game console with a bonus golf video game.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of conducting electronic commerce at a server, the method comprising the server:
publishing an initial group buy offer;
receiving requests from a plurality of group buy participants to participate in the initial group buy offer;
determining that the initial group buy offer is valid once a minimum threshold number of initial group buy participants is met;
offering an incentive to a selected initial group buy participant to share the initial group buy offer;
receiving input from a subsequent group buy participant not included in the plurality of initial group buy participants requesting to participate in the initial group buy offer, wherein the input indicates that the selected initial group buy participant shared the initial group buy offer with the subsequent group buy participant;
determining a relationship between the selected initial group buy participant and the subsequent group buy participant;
assessing a degree of influence the selected initial group buy participant has on the subsequent group buy participant based on the relationship; and
varying the incentive offered to the selected initial group buy participant corresponding to the assessed degree of influence.

2. The method of claim 1, wherein more than one of the initial group buy participants are selected.

3. The method of claim 1, wherein all of the initial group buy participants are selected.

4. The method of claim 1, wherein the incentive comprises a bonus offer provided by a merchant offering the initial group buy offer.

5. The method of claim 1, wherein the incentive comprises an opportunity to participate in a second group buy offer.

6. The method of claim 1, wherein the incentive comprises one or more characteristics, and the method further comprises concealing the one or more characteristics of the incentive until the input is received from the subsequent group buy participant.

7. The method of claim 1, wherein the relationship between the initial group buy participant and the subsequent group buy participant is determined by one or more relationship indicators.

8. The method of claim 7, wherein the one or more relationship indicators comprises a source identifier indicating how the initial group buy participant shared the initial group buy offer with the subsequent group buy participant.

9. The method of claim 7, wherein the one or more relationship indicators comprises one or more personal data elements associated with the subsequent group buy participant.

10. The method of claim 7, wherein assessing the degree of influence further comprises associating a score with each of the one or more relationship indicators; and
calculating a final score based on the score associated with each of the one or more relationship indicators.

11. The method of claim 8, wherein the source identifier corresponds with at least one personal identifier associated with the selected group buy participant, the personal identifier selected from the group consisting of: a social network identifier, an electronic address book identifier, an e-mail address and a personal identification number (PIN).

12. The method of claim 1, further comprising varying the incentive offered to the initial group buy participant based on a social value of the subsequent group buy participant, wherein the social value of the subsequent group buy participant is based on a potential of the subsequent group buy participant to attract new group buy participants to the initial group buy offer.

13. The method of claim 12, wherein the potential of the subsequent group buy participant to attract new group buy participants to the initial group buy offer is based on a total number of connections the subsequent group buy participant has on at least one social network.

14. The method of claim 12, wherein the potential of the subsequent group buy participant to attract new group buy participants to the initial group buy offer is based on a total number of entries in an electronic address book corresponding to an electronic address book identifier associated with the subsequent group buy participant.

15. The method of claim 14, wherein the electronic address book identifier associated with the subsequent group buy participant is selected from the group consisting of: an e-mail address and a personal identification number (PIN).

16. A server for conducting electronic commerce, the server comprising
a processor, and
a memory for storing instructions, which when executed by the processor, cause the processor to:
publish an initial group buy offer;
receive requests from a plurality of group buy participants to participate in the initial group buy offer;
determine that the initial group buy offer is valid once a minimum threshold number of initial group buy participants is met;
offer an incentive to a selected initial group buy participant to share the initial group buy offer;
receive input from a subsequent group buy participant not included in the plurality of initial group buy participants requesting to participate in the initial group buy offer, wherein the input indicates that the selected initial group buy participant shared the initial group buy offer with the subsequent group buy participant;
determine a relationship between the selected initial group buy participant and the subsequent group buy participant;
assess a degree of influence the selected initial group buy participant has on the subsequent group buy participant based on the relationship; and
vary the incentive offered to the selected initial group buy participant corresponding to the assessed degree of influence.

17. A method of conducting electronic commerce at a server, the method comprising the server:
publishing an initial group buy offer;
receiving requests from a first plurality of group buy participants to participate in the initial group buy offer;
indicating the initial group buy offer is valid once a minimum threshold number of group buy participants is met;
receiving additional requests from a second plurality of group buy participants to participate in the initial group buy offer; and
offering an opportunity to participate in a second group buy offer if a total number of group buy participants comprising the first plurality and the second plurality exceeds a predetermined number.

18. The method of claim 17, wherein the second group buy offer comprises one or more characteristics, and the method further comprises concealing the one or more characteristics until the total number of group buy participants exceeds the predetermined number.

19. The method of claim 17, wherein the receiving further comprises:
establishing one or more tiers of group buy participants, each tier comprising a number of group buy participants fewer than the first plurality of group buy participants; and
revealing at least one of the one or more characteristics of the second group buy offer to the group buy participants as each tier of group buy participants is reached.

20. The method of claim 17, wherein the opportunity to participate in the second group buy offer is offered to the first plurality of group buy participants.

21. The method of claim 17, further comprising:
receiving one or more personal data elements associated with at least one of the total number of group buy participants, and
customizing the second group buy offer for the at least one of the total number of group buy participants based on the associated one or more personal data elements.

22. The method of claim 17, further comprising:
receiving one or more personal data elements associated with each of the total number of group buy participants;
identifying a subset of the total number of group buy participants with at least one similar personal data element; and
customizing the second group buy offer for the subset of the number of group buy participants based on the at least one similar personal data element.
